(19) United States
(12) Patent Application Publication
(10) Pub. No.: US 2026/0329013 A1
(43) Pub. Date: Oct. 22, 2026

(54) FIBER ARRAY UNIT INCLUDING FRONT SIDE MIRROR AND METHOD OF MAKING THE SAME

(71) Applicant: Taiwan Semiconductor Manufacturing Company Limited, Hsinchu (TW)

(72) Inventors: Kai-Hung Lo, Chiayi City (TW); Jiun Yi Wu, Zhongli City (TW); Shih Wei Liang, Taichung City (TW); Hua-Kung Chiu, Hsinchu (TW); Chen-Hua Yu, Hsinchu City (TW)

(21) Appl. No.: 19/730,910

(22) Filed: Jul. 3, 2026

Related U.S. Application Data
(62) Division of application No. 18/411,068, filed on Jan. 12, 2024.

(51) Int. Cl. G02B 6/36; G02B 6/35; G02B 6/38

(52) U.S. Cl. CPC G02B 6/3672; G02B 6/3512; G02B 6/3636; G02B 6/3885

(57) ABSTRACT

A fiber array unit includes a support structure, a base on the support structure including an outer base layer, and an inner base layer attached to the outer base layer and including a recess having a recess bottom and a recess sidewall adjoining the recess bottom. The recess may be located at an interface between the outer base layer and the inner base layer and the interface may be substantially perpendicular to the support structure. The fiber array unit also includes a mirror including a reflective layer on the recess bottom and recess sidewall.

### CROSS-REFERENCE TO RELATED APPLICATIONS

This application is a divisional patent application of U.S. Application No. 18/411,068, entitled “Fiber Array Unit Including Front Side Mirror and Method of Making the Same” filed January 12, 2024, which is hereby incorporated by reference in its entirety for all purposes.

### BACKGROUND

A Fiber Array Unit (FAU) is an optical component used in optical systems and devices. The FAU may manipulate and/or direct optical signals carried by one or more optical fibers.

The FAU may include one or more optical fiber ports that may serve as an input interface and/or an output interface for optical signals. The optical fiber ports may be arranged in a linear or two-dimensional array. The FAU may also include a fiber holder (fiber receptacle) for each of the optical fiber ports. The fiber holder (fiber receptacle) may securely hold the optical fibers in place to maintain precise alignment and minimize signal loss.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A is a vertical cross-sectional view of the FAU including the mirror according to one or more embodiments.

FIG. 1B is a vertical cross-sectional view of the FAU including the alignment mirror according to one or more embodiments.

FIG. 1C is a perspective view of the FAU according to one or more embodiments.

FIG. 2A is a detailed vertical cross-sectional view of the FAU including the mirror according to one or more embodiments.

FIG. 2B is a detailed vertical cross-sectional view of the FAU including the alignment mirror according to one or more embodiments.

FIG. 3A is a vertical cross-sectional view of the recess formed in the inner base layer according to one or more embodiments.

FIG. 3B is a vertical cross-sectional view of the inner base layer including the mirror according to one or more embodiments.

FIG. 3C is a vertical cross-sectional view of the inner base layer including the anti-reflective trench according to one or more embodiments.

FIG. 3D is a vertical cross-sectional view of the inner base layer including the trench fill layer in the anti-reflective trench according to one or more embodiments.

FIG. 3E is a vertical cross-sectional view of the inner base layer attached to the outer base layer according to one or more embodiments.

FIG. 3F is a vertical cross-sectional view of the base after performing a dicing process according to one or more embodiments.

FIG. 3G is a vertical cross-sectional view of the base on the support structure 110 according to one or more embodiments.

FIG. 4 is a flow chart illustrating a method of forming an FAU, according to one or more embodiments.

FIG. 5A is a plan view (top-down view) of the first alternative design of the FAU according to one or more embodiments.

FIG. 5B is a vertical cross-sectional view of the first alternative design of the FAU according to one or more embodiments.

FIG. 6 is a vertical cross-sectional view of a second alternative design of the FAU according to one or more embodiments.

FIG. 7 is a vertical cross-sectional view of a third alternative design of the FAU according to one or more embodiments.

### DETAILED DESCRIPTION

The following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The FAU may also include one or more front-side mirrors for directing (redirecting) and/or manipulating optical signals from the optical fibers. The front-side mirrors may include a high-quality, reflective surface that may be positioned at a specific angle within the unit. The front-side mirrors may be used to perform optical processes such as beam steering, signal routing, or splitting.

The FAU may also include one or more actuators to control a position of the front-side mirrors. The actuators may allow for precise adjustments of the mirror's angle, enabling dynamic control of an optical signal path.

The FAU may be enclosed in a housing that provides mechanical protection and ensures that the various parts of the FAU are properly aligned and secured. The FAU may include a microcontroller or microprocessor that controls an operation of the FAU. In particular, the microcontroller or microprocessor may control the actuators to allow for remote and/or automated control of the position of the front-side mirrors. This is particularly useful in dynamic optical systems.

The FAU with a front-side mirror may be used, for example, in optical switching systems to redirect optical signals to different paths. The FAU may also be used in optical test and measurement systems to adjusting direction of optical beams for testing and alignment. The FAU may also be used in laser systems to control the beam path in laser systems for various applications such as laser cutting and medical procedures. The FAU may also be used in optical communication systems to manage a direction of signals in optical networks or for beamforming in optical antennas.

Some embodiments may include a simplified front side mirror (SFSM) in the FAU. The SFSM may direct light from an optical fiber through a silicon structure embedded in a layer of gap fill material and onto a lens. This design of the FAU may present several challenges. First, the design may include a shorter SFSM-to-optical fiber distance which may be constrained by taper glass singulation. Second, the SFSM may need about 15um depth which may require a fabricator of the FAU to re-characterize thicker photoresist with a gray tone mask and etch. Third, the gap fill material (e.g., 1,12-diamine dodecane (DDO) or polyimide (PI)) and warpage may need careful study.

At least one embodiment of the present disclosure may include an FAU having an simplified front side mirror (SFSM). The FAU may have a waveguide-free structure. The FAU may be used, for example, in co-packaged optics that integrate one or more optical components such as lasers and photodetectors within the same package as one or more electronic components (e.g., semiconductor devices) such as microprocessors and switches. This integration may provide a direct connection between the optical components and electronic components, enabling high-speed data transmission and communication within data centers, high-performance computing systems, etc.

In at least one embodiment, the FAU may include a support structure (e.g., slab) and a base (e.g., partial glass base) on the support structure. The support structure may provide mechanical support to the FAU. The base may include an outer base layer and an inner base layer attached to the outer base layer. The inner base layer may be attached to the outer base layer by a general adhesive (e.g., epoxy, silicone adhesive, etc.). The base may be attached to the support structure by optical glue.

The inner base layer may include one or more recesses having a recess bottom and a recess sidewall adjoining the recess bottom. The recess may be located at an interface between the outer base layer and the inner base layer. The interface may be substantially perpendicular to the support structure. The FAU may also include one or more mirrors (e.g., SFSMs) in the one or more recesses, respectively. The mirrors may include a reflective layer on the recess bottom and recess sidewall. The reflective layer may be formed by coating the recess bottom and recess sidewall with a reflective material. In some embodiments, the reflective layer may be formed by coating a surface with the reflective layer material. Thus, the reflective layer may also be referred to as an anti-reflective coating.

The mirrors may include an alignment mirror (e.g., bottom mirror) that provides optical reflection for automatic active alignment. The mirrors may also include a functional mirror (e.g., 45º mirror) for optical path re-direction.

The FAU may have several advantages over current FAUs. In particular, the FAU may allow for a deeper front side mirror (FSM) etch in the inner base layer. This may allow for a wider window of mode field diameter (MFD) acceptance (e.g., 45º angle and 40µm depth). The FAU may also provide excellent complementary optical interconnect (COI) face-let to fiber core which may eliminate any 0.1° concern. The FAU may also provide a simplified COI top (e.g., COIT) which may eliminate the need for a lens. The FAU may also provide for a small COIT dimension (e.g., about 750µm glass plus 85µm silicon bonding by general adhesive). The FAU may also provide for automatic active alignment.

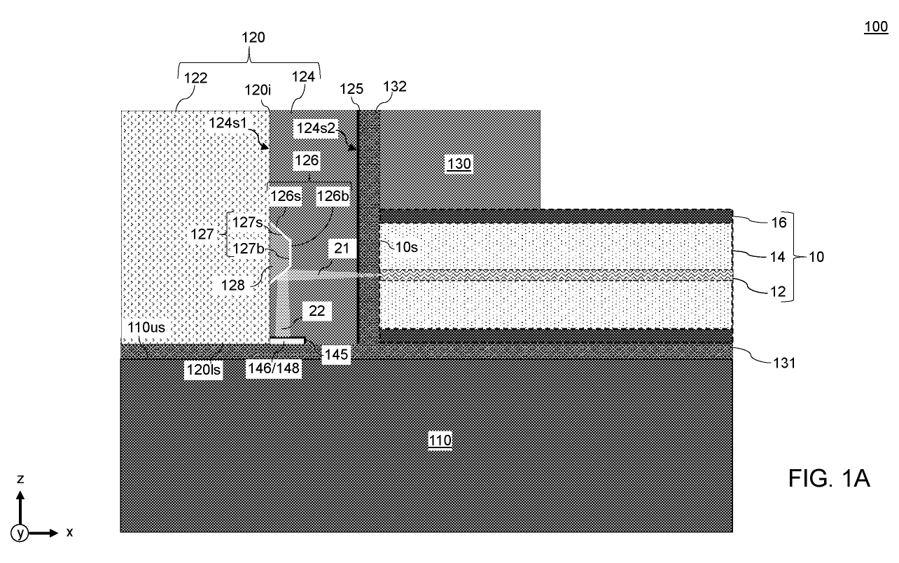

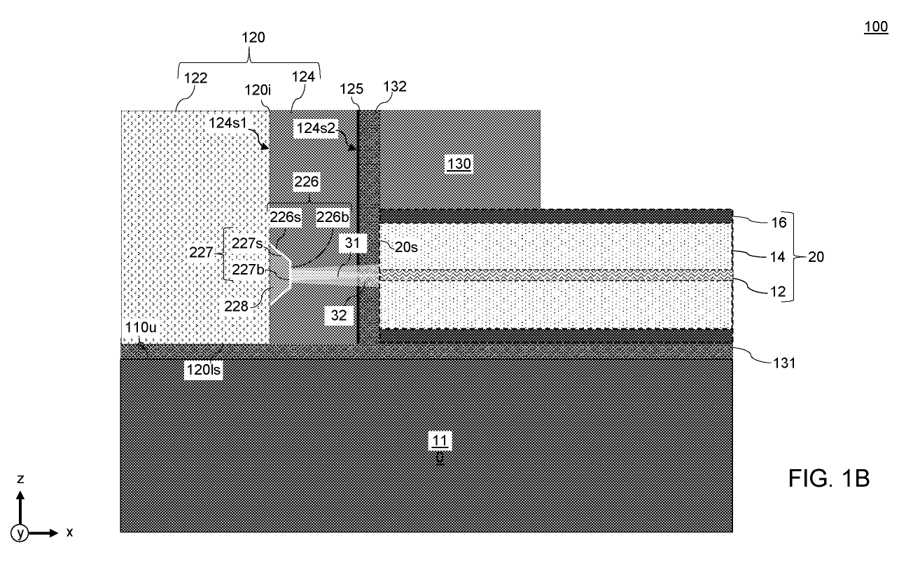

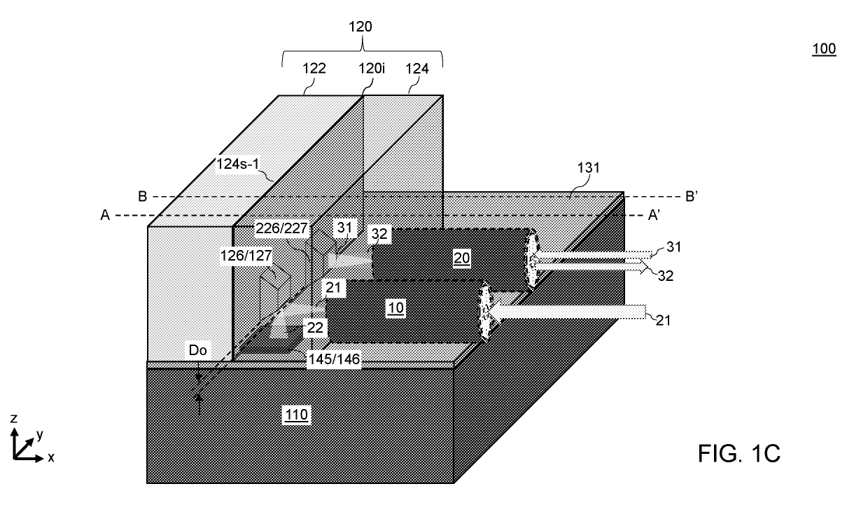

FIGS. 1A-1C are various views of a FAU 100 according to one or more embodiments. FIG. 1A is a vertical cross-sectional view of the FAU 100 including the mirror 127 according to one or more embodiments. FIG. 1B is a vertical cross-sectional view of the FAU 100 including the alignment mirror 227 according to one or more embodiments. FIG. 1C is a perspective view of the FAU 100 according to one or more embodiments. The vertical cross-sectional view in FIG. 1A is a view along the line A-A’ in FIG. 1C. The vertical cross-sectional view in FIG. 1B is a view along the line B-B’ in FIG. 1C.

As illustrated in FIG. 1A, the FAU 100 may include a support structure 110 (e.g., slab) and a base 120 (e.g., partial glass base) on the support structure 110. The support structure 110 may provide mechanical support for the base 120. The support structure 110 may be formed, for example, of an optically transmissive material. In at least one embodiment, the support structure 110 may be formed of aluminum oxide (sapphire), silicon dioxide (e.g., silica glass), doped silica glass, etc. Other materials for the support structure 110 are within the contemplated scope of disclosure. The support structure 110 may have a substantially rectangular or square plate shape. Other shapes for the support structure 110 are within the contemplated scope of disclosure.

The base 120 may include an outer base layer 122 and an inner base layer 124 attached to the outer base layer 122. The outer base layer 122 may include a material that is optically transmissive and in particular, transmissive to ultraviolet (UV) light. The outer base layer 122 may include, for example, glass such as silica glass. Other suitable materials for the outer base layer 122 are within the contemplated scope of disclosure. The inner base layer 124 may include an optically transmissive such as a semiconductor material (e.g., silicon, germanium, silicon germanium, etc.). In at least one embodiment, the inner base layer 124 may include a layer of single crystal silicon. The inner base layer 124 may alternatively include a layer of polycrystalline silicon. Other suitable materials may be used for the inner base layer 124.

The inner base layer 124 may include first side surface 124s1 and a second side surface 124s2 opposite the first side surface 124s1 of the inner base layer 124. The second side surface 124s2 may be substantially parallel with the first side surface 124s1 of the inner base layer 124. The first side surface 124s1 of the inner base layer 124 may be attached to the outer base layer 122 by a general adhesive (not shown) such as epoxy adhesive, silicone adhesive, etc. An interface 120i may be formed between the outer base layer 122 and the first side surface 124s1 of the inner base layer 124. The interface 120i may be substantially perpendicular to an upper surface 110us of the support structure 110. The interface 120i may extend along an entirety of the first side surface 124s1 of the inner base layer 124.

An anti-reflective layer 125 may be formed on the second side surface 124s2 of the inner base layer 124. The anti-reflective layer 125 may reduce reflection and increase the transmission of light at the second side surface 124s2. The anti-reflective layer 125 may include, for example, magnesium fluoride, silicon dioxide, titanium dioxide, zirconium dioxide, hafnium dioxide yttrium fluoride, etc. Other suitable materials may be used for the anti-reflective layer 125. In at least one embodiment, the anti-reflective layer 125 may have a thickness in a range from 50nm to 500nm. In some embodiments, the anti-reflective layer 125 may be formed by coating a surface with the anti-reflective layer 125 material. Thus, the anti-reflective layer 125 may also be referred to as an anti-reflective coating 125.

The first side surface 124s1 of the inner base layer 124 may also include one or more recesses 126. The recess 126 may be located at the interface 120i between the outer base layer 122 and the first side surface 124s1 of the inner base layer 124. The recess 126 may include a recess bottom 126b and one or more recess sidewalls 126s adjoining the recess bottom 126b. The recess 126 may have a tapered shape. In at least one embodiment, a taper angle between the recess sidewalls 126s and the recess bottom 126b may be in a range from 40º to 50º (e.g., 45º). The taper angle between the recess bottom 126b and the recess sidewalls 126 may be the same or different.

In at least one embodiment, the recess 126 may have a truncated pyramid shape with the base of the truncated pyramid being located at the first side surface 124s of the inner base layer 124. In at least one embodiment, the truncated pyramid shape may include a truncated four-sided pyramid shape. Other suitable truncated pyramid shapes may be used for the recess 126.

The recess bottom 126b may be substantially parallel to the second side surface 124s2 of the inner base layer 124. At least one of the recess sidewalls 126s may face in a direction toward the upper surface 110us of the support structure 110. At least one of the recess sidewalls 126s may face in a direction away from the upper surface 110us of the support structure 110. At least one of the recess sidewalls 126s may face in a direction substantially parallel to the upper surface 110us of the support structure 110.

The FAU 100 may also include one or more mirrors 127 (e.g., SFSMs) in the one or more recesses 126, respectively. The mirror 127 may also include a functional mirror (e.g., 45º mirror) for optical path re-direction. The mirror 127 may include one or more layers of reflective coating on the recess bottom 126b and the recess sidewall 126s. The mirror 127 may include a mirror bottom portion 127b on the recess bottom 126b and one or more mirror sidewall portions 127s on the recess sidewalls 126s. That is, the reflective layer on the recess bottom 126b may constitute the mirror bottom portion 127b and the reflective layer on the recess sidewalls 126s may constitute the mirror sidewall portions 127s.

In at least one embodiment, the reflective layer may cover an entirety of the surface of the recess 126. The reflective layer may have a thickness in a range from 50nm to 500nm. The reflective layer may include, for example, one or more layers including aluminum, silver, gold, etc. Other suitable materials may be used for the reflective layer.

At least one of the mirror sidewall portions 127s may face in a direction toward the upper surface 110us of the support structure 110. At least one of the mirror sidewall portions 127s may face in a direction away from the upper surface 110us of the support structure 110. At least one of the sidewall mirror portions 126s may face in a direction substantially parallel to the upper surface 110us of the support structure 110.

The FAU 100 may also include a recess fill layer 128 disposed in the recess 126 on the mirror 127. The recess fill layer 128 may bond to the mirror 127 in the recess 126. A shape of the recess fill layer 128 may be substantially the same as the shape of the recess 126 (e.g., a truncated four-sided pyramid shape). An outer surface of the recess fill layer 128 may be substantially coplanar with the first side surface 124s1 of the inner base layer 124. In at least one embodiment, the outer surface of the recess fill layer 128 may be bonded to the outer base layer 122 by the adhesive that bonds the inner base layer 124 to the outer base layer 122. The recess fill layer 128 may include, for example, an oxide such as silicon oxide. Other suitable materials may be used for the recess fill layer 128.

The base 120 may include a substantially uniform lower surface 120ls that includes a lower surface of the outer base layer 122 and a lower surface of the inner base layer 124. The lower surface 120ls of the base 120 may be attached to the upper surface 110us of the support structure 110 by a first optical glue layer 131. The first optical glue layer 131 when cured may be optically transmissive and may avoid optical distortions or interfere with the optical performance in the FAU 100.

The first optical glue layer 131 may include, for example, an epoxy resin having a low optical absorption, ultra-violet curable (UV-curable) adhesive, silicone-based adhesive, optical cement, cyanoacrylate adhesive, etc. Other materials for the first optical glue layer 131 are within the contemplated scope of disclosure.

As illustrated in FIG. 1A, one or more first optical fibers 10 may also be attached to the FAU 100. In particular, a first optical fiber 10 (optical fiber) may be attached the upper surface 110us of the supporting structure 110 by the optical glue 131. The upper surface 110us of the supporting structure 110 may include one or more grooves (not shown) for supporting the one or more optical fibers 10, respectively. In some embodiments, the grooves may be V-grooves.

The first optical fiber 10 may include a single-mode optical fiber or multi-mode optical fiber. In at least one embodiment, the first optical fiber 10 may not be considered a necessary part of the FAU 100. That is, the first optical fiber 10 may be considered to interface with the FAU 100, and the FAU 100 may redirect or manipulate optical signals transmitted by the first optical fiber 10.

As further illustrated in FIG. 1A, the first optical fiber 10 may include a core 12, a cladding layer 14 around the core 12, and a coating 16 around the cladding layer 14. In at least one embodiment, the first optical fiber 10 may additionally include strengthening fibers (not shown) on the coating 16 and a cable jacket (not shown) on the strengthening fibers.

The core 12 may transmit optical signals through the first optical fiber 10. The core 12 may be made of glass (e.g., silica glass) or hard polymer material. Other suitable materials may be used for the core 12. In at least one embodiment, the glass used in the core 12 may include extremely pure silicon dioxide (SiO₂). Dopants such as Germania, phosphorous pentoxide, or alumina may also be added to the glass in the core 12 to raise the refractive index under controlled conditions.

The core 12 may be surrounded by the cladding layer 14. The cladding layer 14 may have a lower refractive index than the core 12. The cladding layer 14 may also be made of glass (e.g., silica glass) or hard polymer material. Other suitable materials may be used for the cladding layer 14.

In embodiments in which glass is used in the cladding layer 14, the cladding layer 14 and the core 12 may be manufactured together from the same silicon dioxide-based material in a permanently fused state. Different amounts of dopants may be added to the core 12 and the cladding layer 14 to maintain a difference in refractive indices between the core 12 and cladding layer 14. In at least one embodiment, the core 12 may have a refractive index of about 1.49 at a wavelength of 1300nm while the cladding 14 may have a refractive index of about 1.47 at a wavelength of 1300nm.

The cladding layer 14 may be surrounded by the coating 16. The coating 16 may serve as a protective layer that absorbs the shocks, nicks, scrapes, and even moisture that could damage the cladding layer 14. The coating 16 may be color-coded to help with identifying the first optical fiber 10. The coating 16 may include, for example, one or more layers. The coating 16 may include an acrylate-based polymer material, a silicone material, carbon, polyimide, polypropylene, polyethylene, polyvinylchloride, etc. Other suitable materials may be used for the coating 16.

The FAU 100 may further include an upper support layer 130 located on the first optical fiber 10. In at least one embodiment, the upper support layer 130 may include a self-aligned inner base layer. A bottom surface of the upper support layer 130 may contact the coating 16 on the first optical fiber 10. An upper surface of the upper support layer 130 may be substantially coplanar with an upper surface of the outer base layer 122 and an upper surface of the inner base layer 124. The upper support layer 130 may help to fix a position of the first optical fiber 10 on the upper surface 110us of the support structure 110. The upper support layer 130 may include, for example, silicon, glass, polymer material, etc. Other suitable materials may be used for the upper support layer 130.

The FAU 100 may further include a second optical glue layer 132 between the second side surface 124s2 of the inner base layer 124 and the upper support layer 130. The second optical glue layer 132 may be formed of the same materials as the first optical glue layer 131. The second optical glue layer 132 may also be located between the second side surface 124s2 of the inner base layer 124 and the end face 10s of the first optical fiber 10. The second optical glue layer 132 may adjoin the first optical glue layer 131 to form an inverted T shape. The second optical glue layer 132 may bond the upper support layer 130 and the end face 10s of the first optical fiber 10 to the second side surface 124s2 of the inner base layer 124. In particular, the second optical glue layer 132 may bond the upper support layer 130 and the end face 10s of the first optical fiber 10 to the anti-reflective coating 125 that is on the second side surface 124s2 of the inner base layer 124.

As illustrated in FIG. 1A, the first optical fiber 10 may be arranged on the upper surface 110us of the support structure 110 such that light transmitted by the core 12 of the first optical fiber 10 is transmitted as a light beam 21 out of the end face 10s of the first optical fiber 10 and onto the mirror 127 in the inner base layer 124. In particular, the light beam 21 may be transmitted in the x-direction substantially parallel to the upper surface 110us of the support structure 110. In particular, the light beam 21 may be transmitted through the second optical glue layer 132, through the anti-reflective coating 125, through the inner base layer 124 and onto the mirror 127.

The recess 126 and the mirror 127 formed in the recess 126 may be located in the inner base layer 124 such that the core 12 of the first optical fiber 10 is substantially aligned in the x-direction with a recess sidewall 126s and therefore, aligned with a mirror sidewall portion 127s of the mirror 127. In particular, the core 12 may be aligned with a mirror sidewall portion 127s that faces in a direction toward the support structure 110. The light beam 21 may be reflected off the mirror sidewall portion 127s as a reflected light beam 22. The reflected light beam 22 may be formed at a 90º angle from the light beam 21. In at least one embodiment, the reflected light beam 22 may be reflected in the z-direction substantially parallel to the first side surface 124s1 of the inner base layer 124 and substantially perpendicular to the upper surface 110us of the support structure 110.

The FAU 100 may further include an anti-reflective trench 146 located at a bottom surface of the inner base layer 124. The reflected light beam 22 may be reflected onto the anti-reflective trench 146. The anti-reflective trench 146 may help to ensure that the reflected light beam 22 may be transmitted out of the inner base layer 124 and into the first optical glue layer 131 (e.g., into the support structure 110) with low optical loss.

The anti-reflective trench 146 may include an inner wall that is coated with an anti-reflective coating 145. The anti-reflective coating 145 may be formed of the same material as the anti-reflective coating 125 on the second side surface 124s2 of the inner base layer 124. A trench fill layer 148 may be formed in the trench 146 on the anti-reflective coating 145. The trench fill layer 148 may be formed of the same material as the recess fill layer 128. In particular, the trench fill layer 148 may include an oxide (e.g., silicon oxide). In at least one embodiment, the trench fill layer 148 may include DDO. A lower surface of the trench fill layer 148 may be substantially coplanar with the bottom surface of the inner base layer 124.

The FAU 100 may further include one or more photodiodes (not shown) that may receive the reflected light beam 22 transmitted through the trench fill layer 148. The photodiodes may be located, for example on the upper surface 110us of the support structure 110. The photodiodes may alternatively or additionally be located within the support structure 110 or on the lower surface of the support structure 110. The photodiodes may be included as part of a photodiode array that may be included in the FAU 100.

The embodiment illustrated in FIG. 1B is similar to the embodiment illustrated in FIG. 1A. For sake of brevity, similar features are not discussed again. As illustrated in FIG. 1B, the inner base layer 124 may further include an alignment recess 226. Although it is not shown in FIG. 1B, the FAU 100 may optionally include an anti-reflective trench (similar to the anti-reflective trench 146) under the alignment recess 226. The alignment recess 226 may be formed in the first side surface 124s1 of the inner base layer 124 and at the interface 120i between the outer base layer 122 and the inner base layer 124. The alignment recess 226 may be adjacent the recess 126 but offset in the z-direction compared to the recess 126. In particular, a distance between the alignment recess 226 and the upper surface 110us of the support structure 110 may be less than a distance between the recess 126 and the upper surface 110us of the support structure 110.

The alignment recess 226 may have a size and shape substantially similar to the size and shape of the recess 126 in the inner base layer 124. The alignment recess 226 may have an alignment recess bottom 226b substantially similar to the recess bottom 126b and one or more alignment recess sidewalls 226s substantially similar to the recess sidewalls 126s.

The FAU 100 may further include an alignment mirror 227 formed in the alignment recess 226. The alignment mirror 227 may provide for automatic active alignment process in the FAU 100. The alignment mirror 227 may be formed of a reflective layer on the alignment recess bottom 226b and alignment recess sidewall 226s. The reflective layer may be substantially similar to the reflective layer that forms the mirror 127. The alignment mirror 227 may include an alignment mirror bottom portion 227b formed on the alignment recess bottom 226b and one or more alignment mirror sidewall portions 227s formed on the one or more alignment recess sidewalls 226s. The alignment mirror sidewall portions 227s may adjoin the alignment mirror bottom portion 227b.

An alignment recess fill layer 228 may be formed in the alignment recess 226 on the alignment mirror 227. The alignment recess fill layer 228 may bond to the alignment mirror 227 in the alignment recess 226. A shape of the alignment recess fill layer 228 may be substantially the same as the shape of the alignment recess 226 (e.g., a truncated four-sided pyramid shape). An outer surface of the alignment recess fill layer 228 may be substantially coplanar with the first side surface 124s1 of the inner base layer 124. In at least one embodiment, the outer surface of the alignment recess fill layer 228 may be bonded to the outer base layer 122 by the adhesive that bonds the inner base layer 124 to the outer base layer 122. The alignment recess fill layer 228 may include, for example, an oxide such as silicon oxide. Other suitable materials may be used for the recess fill layer 228.

A second optical fiber 20 (alignment optical fiber) may be attached to the upper surface 110us of the support structure 110. The second optical fiber 20 may have a structure substantially similar to the structure of the first optical fiber 10 and may be located adjacent the first optical fiber 10 on the upper surface 110us of the support structure 110. An end face 20s of the second optical fiber 20 may be bonded to the second side surface 124s2 of the inner base layer 124 (e.g., bonded to the anti-reflective coating 125 on the second side surface 124s2 of the inner base layer 124). The upper support layer 130 may also be located on the second optical fiber 20.

As illustrated in FIG. 1B, the second optical fiber 20 may be arranged on the upper surface 110us of the support structure 110 such that light transmitted by the core 12 of the second optical fiber 20 is transmitted as a light beam 31 out of the end face 20s of the second optical fiber 20 and onto the alignment mirror 227 in the inner base layer 124. In particular, the light beam 31 may be transmitted in the x-direction substantially parallel to the upper surface 110us of the support structure 110. In particular, the light beam 31 may be transmitted through the second optical glue layer 132, through the anti-reflective coating 125, through the inner base layer 124 and onto the alignment mirror 227.

The alignment recess 226 and the alignment mirror 227 formed in the alignment recess 226 may be located in the inner base layer 124 such that the core 12 of the second optical fiber 20 is substantially aligned in the x-direction with the alignment recess bottom 226b and therefore, aligned with the alignment mirror bottom portion 227b of the alignment mirror 227. The light beam 31 may be reflected off the alignment mirror bottom portion 227b as a reflected light beam 32. The reflected light beam 32 may be reflected directly back over (e.g., 180º) the light beam 31. In at least one embodiment, the reflected light beam 32 may be reflected in the x-direction back into the core 12 of the second optical fiber 20. In at last one embodiment, a center of the reflected light beam 32 may be substantially coincident with a center of the light beam 31 and with the core 12 of the second optical fiber 20. The reflected light beam 32 may be directed into the core 12 at the end face 20s of the second optical fiber 20 and be transmitted in the core 12 away from the FAU 100. The reflected light beam 32 may be used, for example, to perform automatic active alignment.

Referring to FIG. 1C, the anti-reflective coating 125, the second optical glue layer 132 and the upper support layer 130 are omitted from FIG. 1C for ease of understanding. As illustrated in FIG. 1C, the second optical fiber 20 may be substantially parallel to the first optical fiber 10 on the upper surface 110us of the support structure 110. The alignment recess 226 and alignment mirror 227 may be offset in the z-direction from the recess 126 and mirror 127, by an offset distance Do. The offset distance Do may be substantially the same as a height in the z-direction of the alignment mirror bottom portion 227b. In at least one embodiment, the offset distance Do may be greater than the height of the alignment mirror bottom portion 227b. In at least one embodiment, the offset distance Do may be in a range from 5µm to 100µm.

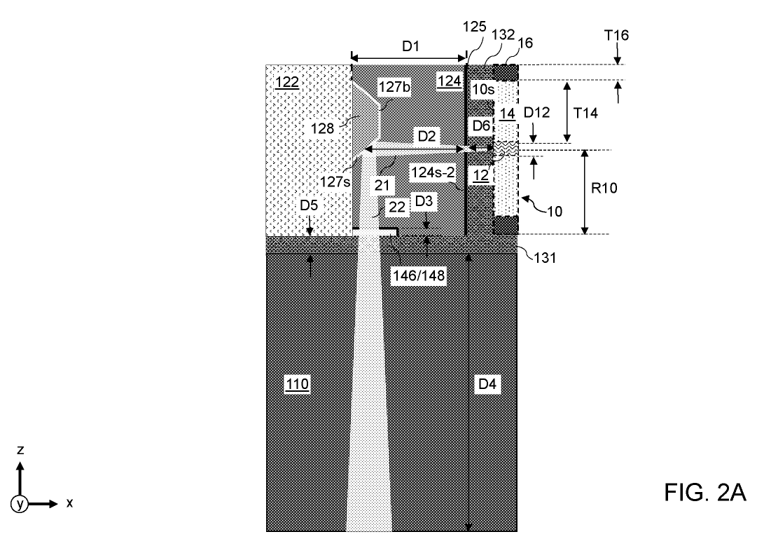

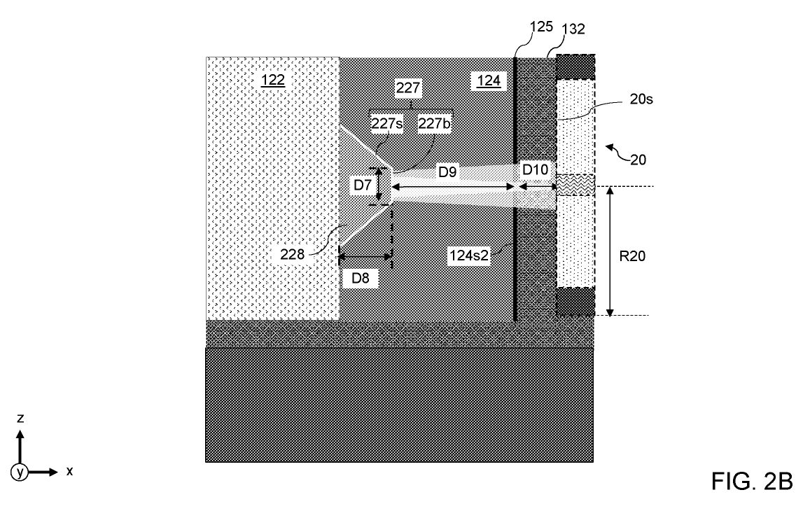

FIGS. 2A-2B are detailed vertical cross-sectional views of the FAU 100 according to one or more embodiments. FIG. 2A is a detailed vertical cross-sectional view of the FAU 100 including the mirror 127 according to one or more embodiments. FIG. 2B is a detailed vertical cross-sectional view of the FAU 100 including the alignment mirror 227 according to one or more embodiments.

As illustrated in FIG. 2A, in at least one embodiment, the inner base layer 124 (e.g., silicon layer, silicon wafer, etc.) may have a width D1 in the x-direction in a range from 50µm to 125µm (e.g., about 85µm). The outer base layer 122 may have a width in the x-direction in a range from 500µm to 1000µm (e.g., about 750µm).

A distance D2 between the second side surface 124s2 of the inner base layer 124 and the mirror sidewall portion 127s at a center of the light beam 21 may be in a range from 30µm to 100µm (e.g., about 65µm). A thickness D3 of the anti-reflective trench 146 (e.g., a thickness of the trench fill layer 148) may be in a range from 1µm to 10µm (e.g., about 5µm). A thickness D4 of the support structure 110 may be in a range from 100µm to 400µm (e.g., about 250µm). A thickness D5 of the first optical glue layer 131 may be in a range from 5µm to 40µm (e.g., about 20µm). A thickness D6 of the second optical glue layer 132 (e.g., distance between the anti-reflective coating 125 and the end face 10s of the first optical fiber 10) may also be in a range from 5µm to 40µm (e.g., about 20µm).

A cross-sectional radius R10 of the first optical fiber 10 may be in a range from 20µm to 200µm (e.g., about 62.5µm). The core 12 may have a diameter D12 in a range from 9µm to 62.5µm. The cladding layer 14 may have a thickness T14 in a range from 30µm to 100µm. The coating 16 may have a thickness T16 in a range from 10µm to 60µm.

In at least one embodiment, the area of the mirror sidewall portion 127s may depend upon the diameter D12 of the core 12 and the combined distance D2+D6 (i.e., the distance D2 between the second side surface 124s2 of the inner base layer 124 and the mirror sidewall portion 127s plus the distance D6 between the anti-reflective coating 125 and the end face 10s of the first optical fiber 10). The area of the mirror sidewall portion 127s should be sufficient to accommodate the light beam 21. If the area of the mirror sidewall portion 127s is too small, then only a portion of the light beam 21 may strike the mirror sidewall portion 127s and be reflected as the reflected light beam 22. In addition, considering that the diameter of the light beam 21 striking the mirror sidewall portion 127s may increase with an increase of the combined distance D2+D6, a ratio of the area of the mirror sidewall portion 127s to the diameter D12 of the core 12 should increase as the combined distance D2+D6 increases. In at least one embodiment, an area of the mirror sidewall portion 127s may be at least twice the cross-sectional area of the core 12 for a combined distance D2+D6 in a range from 35µm to 140µm (e.g., about 85µm).

As illustrated in FIG. 2B, a width D7 of the alignment mirror bottom portion 227b may be substantially the same as a width of the alignment recess bottom 226b. In at least one embodiment, the width D7 of the alignment mirror bottom portion 227b may be in a range from 5µm to 50µm (e.g., about 20µm). A depth D8 of the alignment recess 226 (e.g., a thickness of the alignment recess fill layer 228) may be in a range from 10µm to 70µm (e.g., about 40µm). It should be noted that the dimensions of the recess 126 and the mirror 127 (see FIG. 2A) may be substantially the same as the dimensions of the alignment recess 226 and the alignment mirror 227, respectively. Thus, for example, a width of the mirror bottom portion 127b may be substantially the same as the width D7 of the alignment mirror bottom portion 227b, and the depth of the recess 126 may be substantially the same as the depth D8 of the alignment recess 226.

A distance D9 between the second side surface 124s2 of the inner base layer 124 and the alignment mirror bottom portion 227b may be in a range from 20µm to 70µm (e.g., about 45µm). A distance between the anti-reflective coating 125 and the end face 20s of the second optical fiber 20 (e.g., a thickness of the second optical glue layer 132) may be in a range from 5µm to 40µm (e.g., about 20µm).

A size and shape of the second optical fiber 20 may be substantially similar to the size and shape of the first optical fiber 10. In particular, a cross-sectional radius R20 of the second optical fiber 20 may be in a range from 20µm to 100µm (e.g., about 62.5µm). Further, an area of the alignment mirror bottom portion 227b may depend upon the diameter D12 of the core 12 and the combined distance D9+D10 (i.e., the distance D9 between the second side surface 124s2 of the inner base layer 124 and the alignment mirror bottom portion 227b plus the distance D10 between the anti-reflective coating 125 and the end face 20s of second optical fiber 20). The area of the alignment mirror bottom portion 227b should be sufficient to accommodate the light beam 31. If the area of the alignment mirror bottom portion 227b is too small, then only a portion of the light beam 31 may strike the alignment mirror bottom portion 227b and be reflected as the reflected light beam 32. In addition, considering that the diameter of the light beam 31 striking the alignment mirror bottom portion 227b may increase with an increase of the combined distance D9+D10, a ratio of the area of the alignment mirror bottom portion 227b to the diameter D12 of the core 12 should increase as the combined distance D9+D10 increases. In at least one embodiment, an area of the alignment mirror bottom portion 227b may be at least twice the cross-sectional area of the core 12 for a combined distance D9+D10 in a range from 25µm to 120µm (e.g., about 65µm).

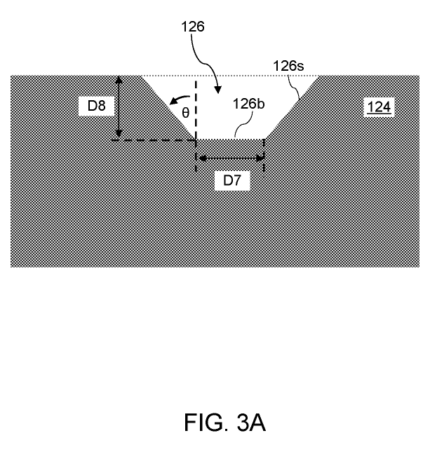

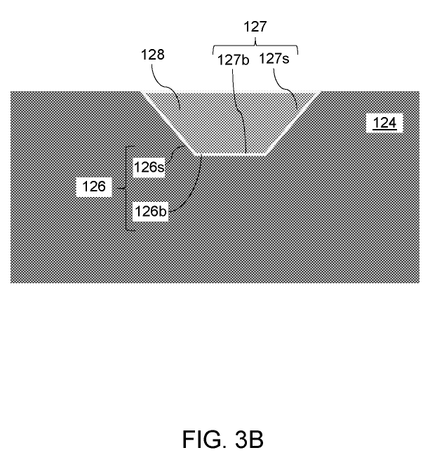

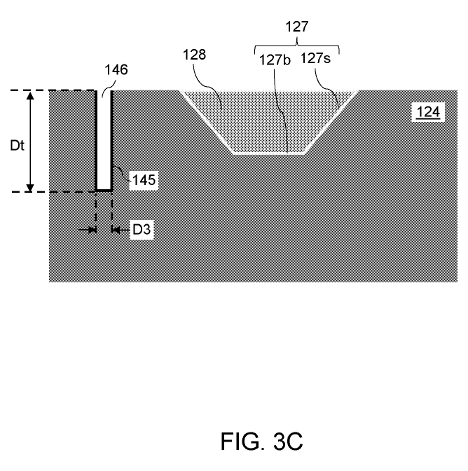

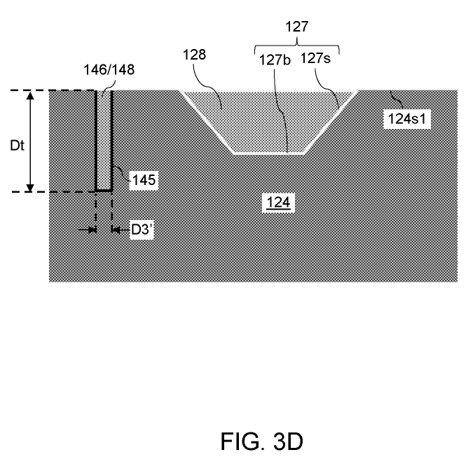

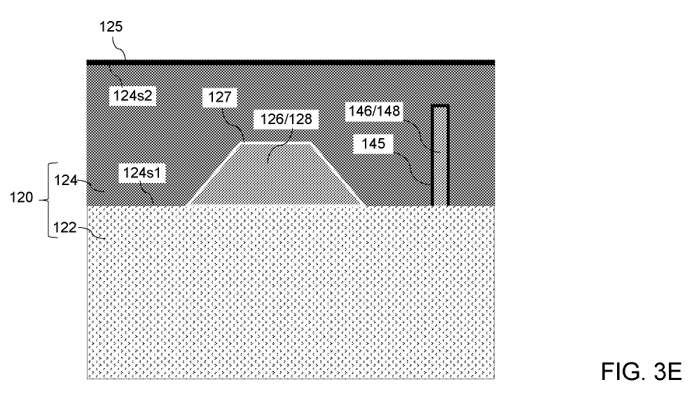

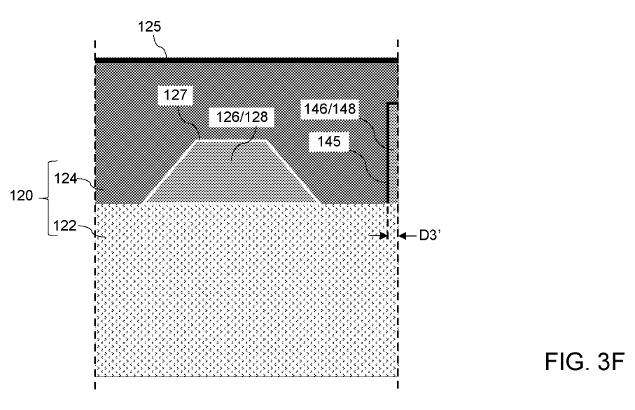

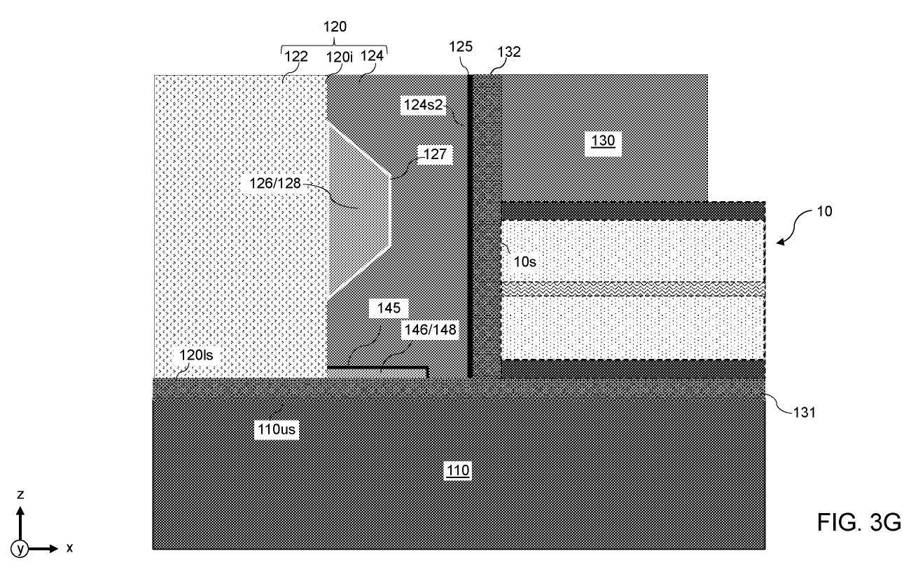

FIGS. 3A-3H illustrate various intermediate structures that may be formed in a method of making the FAU 100 according to one or more embodiments. FIG. 3A is a vertical cross-sectional view of the recess 126, 226 formed in the inner base layer 124 according to one or more embodiments.

The inner base layer 124 may include, for example, a silicon wafer. In at least one embodiment, multiple recesses 126, 226 may be simultaneously formed in the silicon wafer in a wafer level process.

The recess 126, 226 may be formed in the inner base layer 124, for example, by a photolithographic process in which a photoresist layer (not shown) is deposited on the inner base layer 124 and patterned to form an opening in the photoresist layer corresponding to the recess 126, 226. The inner base layer 124 may then be etched (e.g., by wet etching, dry etching, etc.) through the opening in the photoresist layer. In at least one embodiment, a wet etching may be used in order to form the recess 126, 226.

The etching may form the recess 126, 226 to have a depth D8 in a range from 10µm to 70µm (e.g., about 40µm) and a taper angle θ in a range from 40º to 50º (e.g., 45º). The etching may also form the recess bottom 126b, 226b and the recess sidewalls 126s, 226s. The recess bottom 126b, 226b may be formed to have a width D7 in a range from 5µm to 50µm (e.g., about 20µm). The recess sidewall 126s may be formed to have a length in a range from 50µm to 60µm (e.g., about 56.6µm for a depth D8 of 40µm and taper angle of 45º). The photoresist layer may then be removed from the surface of the inner base layer 124 (e.g., by ashing or other suitable process). It should be noted that the same processes used to form the recess 126 may also be used to form the alignment recess 226. Other suitable methods of forming the recess 126 in the inner base layer 124 may be used.

FIG. 3B is a vertical cross-sectional view of the inner base layer 124 including the mirror 127, 227 according to one or more embodiments. In at least one embodiment, the mirror 127, 227 may be formed on the recess bottom 126b, 226b and the recess sidewalls 126s, 226s of the recess 126, 226 by depositing a reflective layer on the recess bottom 126b, 226b and the recess sidewalls 126s, 226s. As illustrated in FIG. 3B, the reflective layer or reflective coating may be conformally formed on the recess bottom 126b, 226b and the recess sidewalls 126s, 226s. The reflective layer may be deposited, for example, using a deposition process such as CVD, PECVD, PVD, spin coating, lamination or other suitable deposition technique. The reflective layer may be deposited to have a thickness in a range from 50nm to 500nm. Other suitable methods of forming the mirror 127 may be used.

The recess fill layer 128 may then be formed in the recess 126, 226 on the mirror 127, 227. The recess fill layer 128, 228 may be formed, for example, by depositing a recess fill material (e.g., an oxide such as silicon oxide) in the recess 126, 226. The recess fill material may be deposited, for example, using a deposition process such as CVD, PECVD, PVD, spin coating, lamination or other suitable deposition technique. The recess fill material may be deposited so as to fill the recess 126, 226. Other suitable methods of forming the recess fill layer 128, 228 may be used.

After the recess fill material is deposited and cured, a planarization process (e.g., chemical mechanical polish (CMP)) may be performed. The planarization process may remove any reflective coating and any recess fill material formed outside the recess 126, 226 on the surface of the inner base layer 124. The planarization process may also make an upper surface of the recess fill material and an upper surface of the reflective coating (e.g., mirror 127, 227) to be substantially coplanar with the surface of the inner base layer 124. The planarization process may include, for example, chemical mechanical polishing (CMP). Other suitable methods may be used in the planarization process.

FIG. 3C is a vertical cross-sectional view of the inner base layer 124 including the anti-reflective trench 146 according to one or more embodiments. The anti-reflective trench 146 may be formed in the surface of the inner base layer 124, for example, by a photolithographic process in which a photoresist layer (not shown) is deposited on the inner base layer 124 and patterned to form an opening in the photoresist layer corresponding to the anti-reflective trench 146. The inner base layer 124 may then be etched (e.g., by wet etching, dry etching, etc.) through the opening in the photoresist layer.

The etching may form the anti-reflective trench 146 to have a depth Dt greater than a depth D8 of the recess 126. In at least one embodiment, the depth Dt may be in a range from 71µm to 120µm (e.g., about 90µm). The etching may also form the anti-reflective trench 146 to have a thickness D3’ greater than the finished thickness D3 (e.g., greater than about 10 µm). The sidewalls of the anti-reflective trench 146 may be substantially perpendicular to the surface of the inner base layer 124. The photoresist layer may then be removed from the surface of the inner base layer 124 (e.g., by ashing or other suitable process). It should be noted that the same processes used to form the anti-reflective trench 146 may also be used to form the alignment recess 226. Other suitable methods of forming the anti-reflective trench 146 in the inner base layer 124 may be used.

The anti-reflective coating 145 may then be formed in the anti-reflective trench 146. The anti-reflective coating 145 may be formed, for example, by depositing the anti-reflective coating 145 on the bottom and sidewalls of the anti-reflective trench 146. The anti-reflective coating 145 may be deposited, for example, using a deposition process such as CVD, PECVD, PVD, spin coating, lamination or other suitable deposition technique. The anti-reflective coating 145 may be deposited to have a thickness in a range from 50nm to 500nm. Other suitable methods of forming the anti-reflective coating 145 may be used.

A planarization process may then be performed. The planarization process may remove any anti-reflective coating formed outside the anti-reflective trench 146 on the surface of the inner base layer 124. The planarization process may also make an upper surface of the anti-reflective coating to be substantially coplanar with the surface of the inner base layer 124. The planarization process may include, for example, chemical mechanical polishing (CMP). Other suitable methods may be used in the planarization process.

FIG. 3D is a vertical cross-sectional view of the inner base layer 124 including the trench fill layer 148 in the anti-reflective trench 146 according to one or more embodiments. The trench fill layer 148 may be formed (e.g., conformally formed) in the anti-reflective trench 146 on the bottom and sidewalls of the anti-reflective trench 146. The trench fill layer 148 may be formed, for example, by depositing a trench fill material in the recess 126. The trench fill material may include, for example, an oxide (e.g., silicon oxide) or DDO. The trench fill material may be deposited, for example, using a deposition process such as CVD, PECVD, PVD, spin coating, lamination or other suitable deposition technique. The trench fill material may be deposited so as to fill the anti-reflective trench 146. Other suitable methods of forming the trench fill layer 148 may be used.

A planarization process may then be performed. The planarization process may remove any trench fill material formed outside the anti-reflective trench 146 on the surface of the inner base layer 124. The planarization process may form the first side surface 124s1 of the inner base layer 124. The planarization process may also make an upper surface of the trench fill layer 148 to be substantially coplanar with the first side surface 124s1 of the inner base layer 124. The planarization process may include, for example, chemical mechanical polishing (CMP). Other suitable methods may be used in the planarization process.

FIG. 3E is a vertical cross-sectional view of the inner base layer 124 attached to the outer base layer 122 according to one or more embodiments. The base 120 may then be formed by attaching the inner base layer 124 to the outer base layer 122.

An adhesive layer (not shown) such as silicone adhesive, epoxy adhesive, etc. may be applied to a surface of the outer base layer 122. The adhesive layer may be applied, for example, by spraying, spin coating, lamination, etc. The inner base layer 124 may then be inverted so that the first side surface 124s1 of the inner base layer 124 faces the surface of the outer base layer 122. The inner base layer 124 may then be lowered onto the outer base layer 122. The inner base layer 124 and outer base layer 122 may then be clamped together and the adhesive cured (e.g., in a curing oven).

After the adhesive is cured, the surface of the inner base layer 124 opposite the outer base layer 122 may be ground and polished to form the second side surface 124s2 of the inner base layer 124. The anti-reflective coating 125 may then be formed on the second side surface 124s2 of the inner base layer 124. The anti-reflective coating 125 may be formed, for example, by depositing the anti-reflective coating 125 on the second side surface 124s2. The anti-reflective coating 125 may be deposited, for example, using a deposition process such as CVD, PECVD, PVD, spin coating, lamination or other suitable deposition technique. The anti-reflective coating 125 may be deposited to have a thickness in a range from 50nm to 500nm. Other suitable methods of forming the anti-reflective coating 125 may be used.

FIG. 3F is a vertical cross-sectional view of the base 120 after performing a dicing process according to one or more embodiments. The dicing process may be performed, for example, using a die saw. The dicing may be performed along the dashed lines in FIG. 3F. As illustrated in FIG. 3F, the dicing may remove a portion of the anti-reflective trench 146. In particular, the dicing may result in the anti-reflective trench 146 having the thickness D3 in a range from 1µm to 10µm (e.g., about 5µm).

FIG. 3G is a vertical cross-sectional view of the base 120 on the support structure 110 according to one or more embodiments. As illustrated in FIG. 3G, the first optical glue layer 131 (e.g., a UV-curable optical glue) may be formed on the upper surface 110us of the support structure 110 (e.g., a sapphire slab). The base 120 may then be rotated 90º and positioned over the support structure 110 so that the lower surface 120ls of the base 120 faces the upper surface 110us of the support substrate 110. The base 120 may be positioned, for example, using an electromechanical pick-and-place (PNP) machine. The base 120 may then be lowered onto the first optical glue layer 131 so that the lower surface 120ls of the base 120 (e.g., including the anti-reflective trench 146) contacts the first optical glue layer 131, and the interface 120i is substantially perpendicular to the support structure 110.

The second optical glue layer 132 may then be applied to the anti-reflective coating 125 on the second side surface 124s2 of the inner base layer 124. The second optical glue layer 132 may be applied in a manner similar to that of the first optical glue layer 131. The first optical fiber 10 may then be placed on the first optical glue layer 131 so that the end face 10s of the first optical fiber 10 contacts the second optical glue layer 132. An adhesive layer (not shown) may then be applied to the top of the first optical fiber 10 and the upper support 130 may then attached to the first optical fiber 10 and to the inner base layer 124 by the second optical glue layer 132. The structure may then be clamped together (e.g., between the base 120/upper support 130 and the support structure 110). The first optical glue layer 131 and second optical glue layer 132 may then be cured (e.g., using UV light).

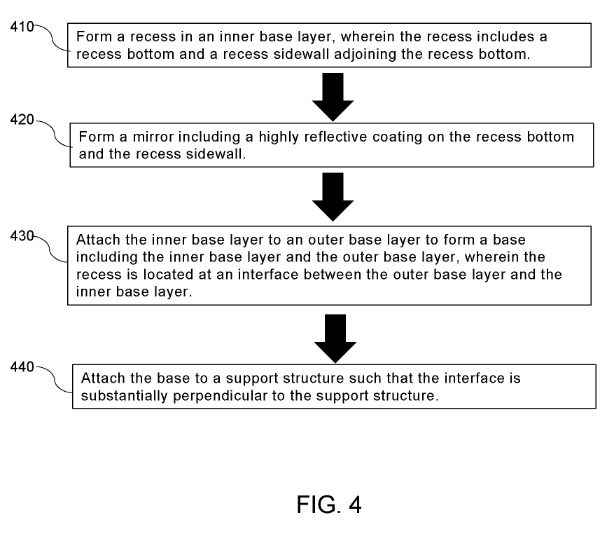

FIG. 4 is a flow chart illustrating a method of forming an FAU 100, according to one or more embodiments. Step 410 of the method may include forming a recess 126, 226 in an inner base layer 124, wherein the recess 126, 226 comprises a recess bottom126b, 226b and a recess sidewall 126s, 226s adjoining the recess bottom 126b, 226b. Step 420 may include forming a mirror 127, 227 comprising a reflective coating on the recess bottom 126b, 226b and the recess sidewall 126s, 226s. Step 430 may include attaching the inner base layer 124 to an outer base layer 122 to form a base 120 including the inner base layer 124 and the outer base layer 122, wherein the recess 126, 226 is located at an interface between the outer base layer 122 and the inner base layer 124. Step 440 may include attaching the base 120 to a support structure 110 such that the interface 120i is substantially perpendicular to the support structure 110.

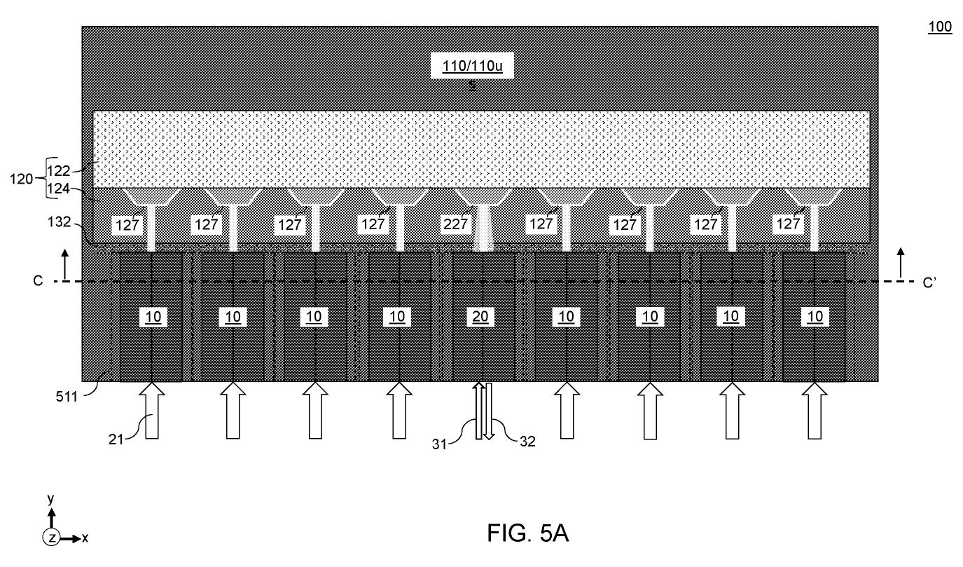

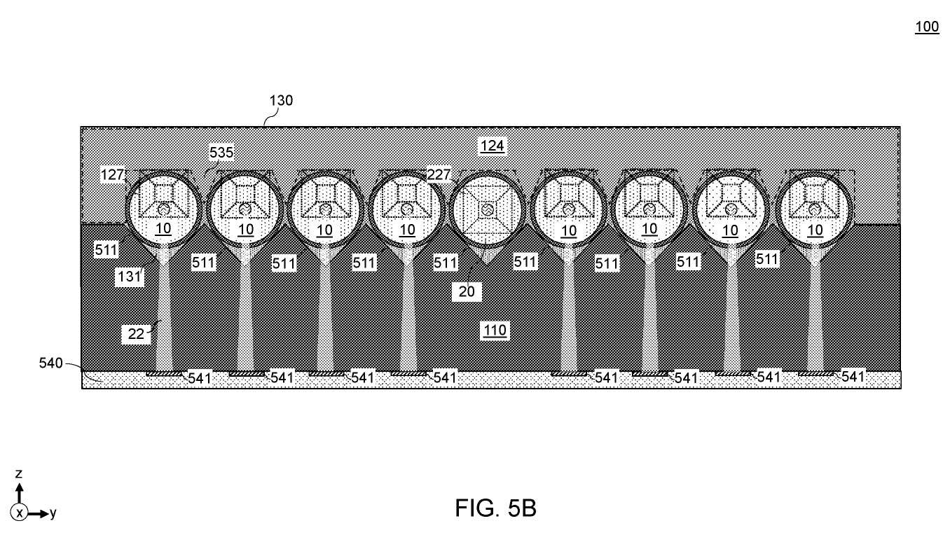

FIGS. 5A-5B illustrate a first alternative design of the FAU 100 according to one or more embodiments. FIG. 5A is a plan view (top-down view) of the first alternative design of the FAU 100 according to one or more embodiments. FIG. 5B is a vertical cross-sectional view of the first alternative design of the FAU 100 according to one or more embodiments. The vertical cross-sectional view in FIG. 5B is a view along the line C-C’ in FIG. 5A.

In FIG. 5A, the upper support 130 and the first optical glue layer 131 have been omitted for ease of understanding. As illustrated in FIG. 5A, in the first alternative design, the support structure 110 may have an area in the plan view greater than an area of the base 120. The upper surface 110us of the support structure 110 may include a plurality of grooves 511 extending in the y-direction. The plurality of grooves 511 may accommodate a plurality of first optical fibers 10 and the second optical fiber 20 (alignment optical fiber), respectively. The number of first optical fibers 10 and second optical fibers 20 is not necessarily limited to any particular number. The plurality of first optical fibers 10 and the second optical fiber 20 may be fixed in position by the first optical glue layer (not shown) and the second optical glue layer 132.

The inner base layer 124 may include a plurality of mirrors 127 and the alignment mirror 227. The plurality of mirrors 127 may be configured to receive the light beam 21 from the first optical fibers 10. The alignment mirror 227 may be configured to receive the light beam 31 from the second optical fiber 20.

In FIG. 5B, a location of the upper support 130 is indicated by a dashed line for ease of understanding. A location of the plurality of mirrors 127 and the alignment mirror 227 is also indicated by a dashed line for ease of understanding.

As illustrated in FIG. 5B, the plurality of first optical fibers 10 and the second optical fiber 20 may be seated on the lateral sidewalls of the plurality of grooves 511. This may help to ensure that the first optical fibers 10 are properly axially aligned with the plurality of mirrors 127 and the second optical fiber 20 is properly axially aligned with the alignment mirror 227. The plurality of first optical fibers 10 and the second optical fiber 20 may be fixed in the plurality of grooves 511 by the first optical glue layer 131.

As further illustrated in FIG. 5B, the upper support 130 in the first alternative design may have an inverted U-shape. The upper support 130 may also include a plurality of projections 535 projecting downward between the plurality of first optical fibers 10 and the second optical fiber 20. In at least one embodiment, the projections 535 may include V-shaped projections. With this configuration, the upper support 130 may allow the upper support 130 to restrict a movement of the plurality of first optical fibers 10 and the second optical fiber 20 in both the z-direction and laterally in the y-direction.

The first alternative design of the FAU 100 may also include a photodiode array 540. The photodiode array 540 may be attached to a lower surface of the support structure 110. The photodiode array 540 may include a plurality of photodiodes 541 that receive the reflected light beams 22 from the plurality of mirrors 127, respectively. The photodiode array 540 may also include electronic circuitry and devices for processing the reflected light beams 22 into electronic signals and utilizing the electronic signals.

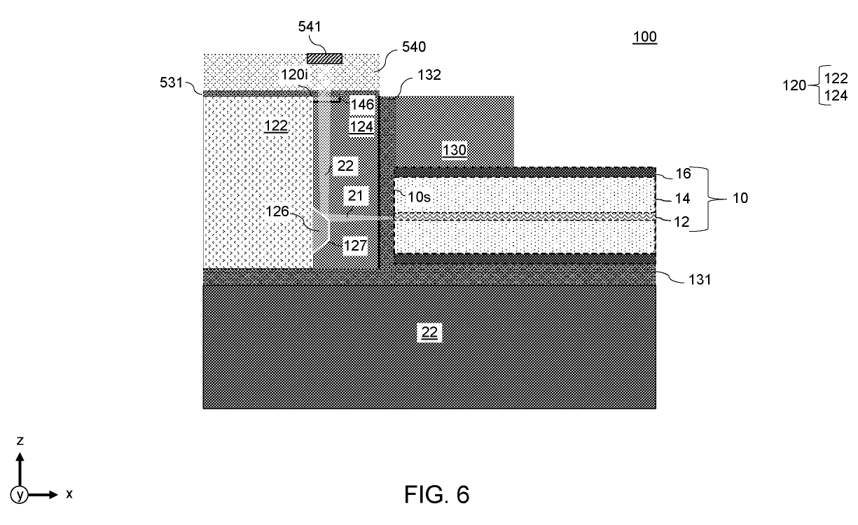

FIG. 6 is a vertical cross-sectional view of a second alternative design of the FAU 100 according to one or more embodiments. As illustrated in FIG. 6, the second alternative design may be substantially the same as the original design in FIGS. 1A-1C. However, in the second alternative design, the FAU 100 may include the photodiode array 540 mounted on the base 120 opposite the support structure 110. The photodiode array 540 may be attached to the base 120 by a third optical glue layer 531. The third optical glue layer 531 may be substantially the same as the first optical glue layer 131 and the second optical glue layer 132.

As further illustrated in FIG. 6, the recess 126 and mirror 127 may configured in the inner base layer 124 such that the light beam 21 from the first optical fiber 10 may strike a mirror sidewall portion 127s of the mirror 127. In particular, the light beam 21 may strike a mirror sidewall portion 127s facing away from the support structure 110 and toward the photodiode array 540. The light beam 21 may be reflected by the mirror sidewall portion 127s to form the reflected beam 22 which is substantially perpendicular to the interface 120i between the outer base layer 122 and the inner base layer 124. The reflected light beam 22 may exit the inner base layer 124 through the anti-reflective trench 146. The reflected light beam 22 may then enter the photodiode array 540 to be received by the photodiode 541.

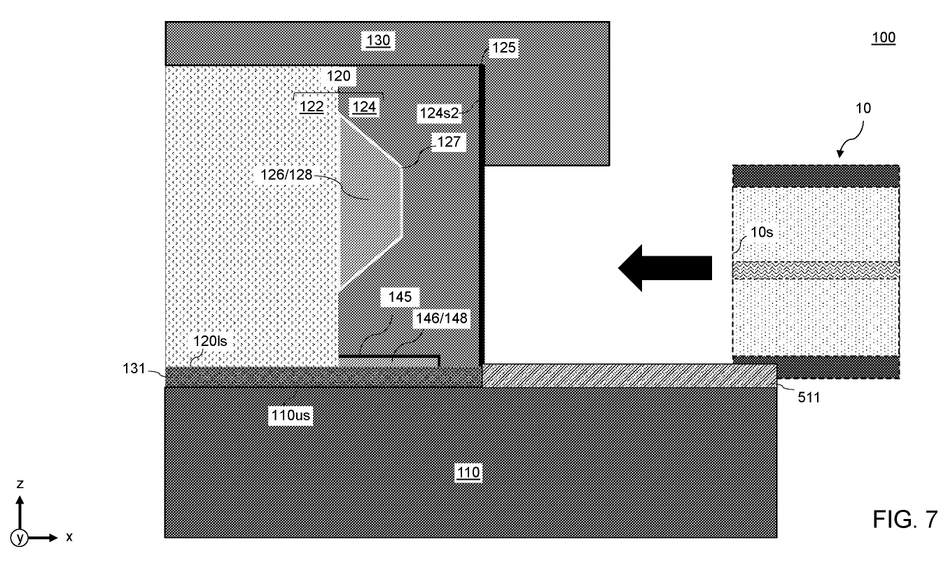

FIG. 7 is a vertical cross-sectional view of a third alternative design of the FAU 100 according to one or more embodiments. As illustrated in FIG. 7, the third alternative design of the FAU 100 may be substantially similar to the embodiments illustrated in FIGS. 1A-1C. As in the earlier embodiments, in the third alternative design, the FAU 100 may include the support structure 110, the base 120 and the upper support 130. However, in the third alternative design the upper support 130 may have an L-shaped cross-section. A portion of the upper support 130 may be attached to the upper surface of the base 120 and a portion of the upper support 130 may be attached to the second side surface 124s2 of the inner base layer 124 (e.g., attached to the anti-reflective coating 125). The upper support 130 may be attached to the base 120 by an adhesive layer (not shown) (e.g., epoxy adhesive, silicone adhesive, etc.).

As further illustrated in FIG. 7, a groove 511 may be formed on the upper surface 110us of the support structure 110. In some embodiments, the groove 511 may be a V-groove. The groove 511, the second side surface 124s2 of the inner base layer 124 and the upper support 130 may together constitute an attachment port (fiber receptacle) of the FAU 100 for receiving the first optical fiber 10 (and also for receiving the second optical fiber (not shown)).

The first optical glue layer (not shown) may be formed in the groove 511. The second optical glue layer (not shown) may be formed on the anti-reflective coating 125. The first optical fiber 10 may then be inserted into the attachment port and attached to the FAU 100 by the first optical glue layer and the second optical glue layer.

Referring now to FIGS. 1A-7, a fiber array unit 100 may include a support structure 110, a base 120 on the support structure 110, wherein the base 120 includes an outer base layer 122, and an inner base layer 124 attached to the outer base layer 122 and including a recess 126, 226 including a recess bottom 126b, 226b and a recess sidewall 126s, 226s adjoining the recess bottom 126b, 226b, wherein the recess 126, 226 may be located at an interface 120i between the outer base layer 122 and the inner base layer 124 and the interface 120i may be substantially perpendicular to the support structure 110, and a mirror 127, 227 including a reflective layer on the recess bottom 126b, 226b and recess sidewall 126s, 226s.

In one embodiment, the recess sidewall 126s, 226s may include a tapered recess sidewall 126s, 226s. In one embodiment, the tapered recess sidewall 126s, 226s may include a taper angle θ in a range from 40º to 50º. In one embodiment, the mirror 127, 227 may include a mirror bottom portion 127b, 227b on the recess bottom 126b, 226b and a mirror sidewall portion 127s, 227s on the recess sidewall 126s, 226s. In one embodiment, the inner base layer 124 may include a first side surface 124s1 including the recess 126, 226, and a second side surface 124s2 opposite the first side surface 124s1 of the inner base layer 124 and substantially parallel with the first side surface 124s1 of the inner base layer 124. In one embodiment, the fiber array unit 100 may further include a recess fill layer 128, 228 in the recess 126, 226 on the mirror 127, 227, wherein an outer surface of the recess fill layer 128, 228 may be substantially coplanar with the first side surface 124s1 of the inner base layer 124. In one embodiment, the fiber array unit 100 may further include an anti-reflective coating 125 on the second side surface 124s2 of the inner base layer 124. The support structure 110 may include an upper surface including a groove 511 configured to support a first optical fiber 10 such that an end face 10s of the first optical fiber 10 faces the second side surface 124s2 of the inner base layer 124. In one embodiment, the mirror 127, 227 may include a functional mirror 127, 227 and the groove 511 may be configured to support the first optical fiber 10 such that a core 12 of the first optical fiber 10 may be substantially aligned with the recess sidewall 126s. In one embodiment, the fiber array unit 100 may further include a first optical glue layer 131 between the base and the support structure 110 and between the first optical fiber 10 and the support structure 110, and a second optical glue layer 132 between the second side surface 124s2 of the inner base layer 124 and the end face 10s of the first optical fiber 10. In one embodiment, the fiber array unit 100 may further include an upper support layer located on the first optical fiber 10, wherein the second optical glue layer 132 may be between the second side surface 124s2 of the inner base layer 124 and the upper support layer. In one embodiment, the first side surface 124s1 of the inner base layer 124 further may include an alignment recess including an alignment recess bottom and an alignment recess sidewall adjoining the alignment recess bottom, and the alignment recess may be located adjacent the recess 126 at the interface 120i between the outer base layer 122 and the inner base layer 124. In one embodiment, the fiber array unit 100 may further include an alignment mirror 227 including a reflective coating on the alignment recess bottom and alignment recess sidewall, wherein the alignment mirror may include an alignment mirror bottom portion 227b on the alignment recess bottom and an alignment mirror sidewall portion 227s on the alignment recess sidewall. In one embodiment, the support structure 110 may include an upper surface including a groove 511 configured to support a second optical fiber 20 such that an end face 20s of the second optical fiber 20 faces the second side surface 124s2 of the inner base layer 124, and such that a core 12 of the second optical fiber 20 may be substantially aligned with the alignment mirror bottom portion 227b.

Referring again to FIGS. 1A-7, a method of forming a fiber array unit 100 may include forming a recess 126, 226 in an inner base layer 124, wherein the recess 126, 226 may include a recess bottom 126b, 226b and a recess sidewall 126s, 226s adjoining the recess bottom 126b, 226b, forming a mirror 127, 227 including a reflective coating on the recess bottom 126b, 226b and the recess sidewall 126s, 226s, attaching the inner base layer 124 to an outer base layer 122 to form a base including the inner base layer 124 and the outer base layer 122, wherein the recess 126, 226 may be located at an interface 120i between the outer base layer 122 and the inner base layer 124, and attaching the base to a support structure 110 such that the interface 120i may be substantially perpendicular to the support structure 110.

In one embodiment, the forming of the recess 126, 226 may include forming the recess sidewall 126s, 226s to include a tapered recess sidewall 126s, 226s including a taper angle θ in a range from 40º to 50º. In one embodiment, the forming of the recess 126, 226 may include forming the recess 126, 226 in a first side surface 124s1 of the inner base layer 124, wherein the inner base layer 124 may include a second side surface 124s2 opposite the first side surface 124s1 of the inner base layer 124 and substantially parallel with the first side surfaces 124s1 of the inner base layer 124. In one embodiment, the method may further include forming a recess fill layer 128, 228 in the recess 126, 226 on the mirror 127, 227, wherein an outer surface of the recess fill layer 128, 228 may be substantially coplanar with the first side surface 124s1 of the inner base layer 124 and forming an anti-reflective coating 125 on the second side surface 124s2 of the inner base layer 124. In one embodiment, the attaching of the base to the support structure 110 may include attaching the base to the support structure 110 such that a groove 511 in an upper surface of the support structure 110 supports a first optical fiber 10 including an end face 10s that faces the second side surface 124s2 of the inner base layer 124 and a core 12 of the first optical fiber 10 may be substantially aligned with the mirror sidewall portion 127s.

Referring again to FIGS. 1A-7, a fiber array unit 100 may include a support structure 110 including a plurality of grooves 511 configured to support a plurality of first optical fibers 10, respectively, a base on the support structure 110 including an outer base layer 122, and an inner base layer 124 attached to the outer base layer 122 and including a plurality of recesses 126 including a recess bottom 126b and a recess sidewall 126s adjoining the recess bottom 126b, wherein the plurality of recesses 126 may be located at an interface 120i between the outer base layer 122 and the inner base layer 124 and the interface 120i may be substantially perpendicular to the support structure 110, a plurality of functional mirrors 127 including a reflective coating on the recess bottom 126b and recess sidewall 126s of the plurality of recesses 126, wherein the plurality of functional mirrors 127 may be configured to reflect a light beam 21 from the first optical fiber 10s in a direction substantially parallel to the interface 120i between the outer base layer 122 and the inner base layer 124, and a photodiode array 540 including a plurality of photodiodes 541 configured to receive the reflected light beam 22 from the plurality of functional mirrors 127, respectively.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A fiber array unit, comprising:
a support structure;
a base on the support structure, comprising:
an outer base layer; and
an inner base layer attached to the outer base layer and including a recess comprising a recess bottom and a recess sidewall adjoining the recess bottom, wherein the recess is located at an interface between the outer base layer and the inner base layer and the interface is substantially perpendicular to the support structure; and
a mirror comprising a reflective layer on the recess bottom and recess sidewall.

2. The fiber array unit of claim 1, wherein the recess sidewall comprises a tapered recess sidewall.

3. The fiber array unit of claim 2, wherein the tapered recess sidewall comprises a taper angle in a range from 40º to 50º.

4. The fiber array unit of claim 1, wherein the mirror comprises a mirror bottom portion on the recess bottom and a mirror sidewall portion on the recess sidewall.

5. The fiber array unit of claim 1, wherein the inner base layer comprises a first side surface including the recess, and a second side surface opposite the first side surface of the inner base layer and substantially parallel with the first side surface of the inner base layer.

6. The fiber array unit of claim 5, further comprising:
a recess fill layer in the recess on the mirror, wherein an outer surface of the recess fill layer is substantially coplanar with the first side surface of the inner base layer.

7. The fiber array unit of claim 5, further comprising:
an anti-reflective layer on the second side surface of the inner base layer.

8. The fiber array unit of claim 5, wherein the support structure comprises an upper surface including a groove configured to support a first optical fiber such that an end face of the first optical fiber faces the second side surface of the inner base layer.

9. The fiber array unit of claim 8, wherein the mirror comprises a functional mirror and the groove is configured to support the first optical fiber such that a core of the first optical fiber is substantially aligned with the recess sidewall.

10. The fiber array unit of claim 8, further comprising:
a first optical glue layer between the base and the support structure and between the first optical fiber and the support structure; and
a second optical glue layer between the second side surface of the inner base layer and the end face of the first optical fiber.

11. The fiber array unit of claim 10, further comprising:
an upper support layer located on the first optical fiber, wherein the second optical glue layer is between the second side surface of the inner base layer and the upper support layer.

12. The fiber array unit of claim 5, wherein the first side surface of the inner base layer further comprises an alignment recess comprising an alignment recess bottom and an alignment recess sidewall adjoining the alignment recess bottom, and the alignment recess is located adjacent the recess at the interface between the outer base layer and the inner base layer.

13. The fiber array unit of claim 12, further comprising:
an alignment mirror comprising a reflective layer on the alignment recess bottom and alignment recess sidewall, wherein the alignment mirror comprises an alignment mirror bottom portion on the alignment recess bottom and an alignment mirror sidewall portion on the alignment recess sidewall.

14. The fiber array unit of claim 13, wherein the support structure comprises an upper surface including an alignment groove configured to support a second optical fiber such that an end face of the second optical fiber faces the second side surface of the inner base layer, and such that a core of the second optical fiber is substantially aligned with the alignment mirror bottom portion.

15. A fiber array unit, comprising:
a support structure including a plurality of grooves configured to support a plurality of first optical fibers, respectively;
a base on the support structure, comprising:
an outer base layer; and
an inner base layer attached to the outer base layer and including a plurality of recesses including a recess bottom and a recess sidewall adjoining the recess bottom, wherein the plurality of recesses is located at an interface between the outer base layer and the inner base layer and the interface is substantially perpendicular to the support structure;
a plurality of functional mirrors comprising a reflective layer on the recess bottom and recess sidewall of the plurality of recesses, wherein the plurality of functional mirrors is configured to reflect a light beam from the first optical fibers in a direction substantially parallel to the interface between the outer base layer and the inner base layer; and
a photodiode array comprising a plurality of photodiodes configured to receive the reflected light beam from the plurality of functional mirrors, respectively.

16. The fiber array unit of claim 15, wherein the photodiode array is attached to a lower surface of the support structure.

17. The fiber array unit of claim 15, further comprising:
an upper support layer having an inverted U-shape and including a plurality of projections projecting downward between the plurality of first optical fibers.

18. A fiber array unit, comprising:
a support structure;
a base on the support structure, comprising an outer base layer and an inner base layer attached to the outer base layer;
a recess formed in the inner base layer at an interface between the outer base layer and the inner base layer, the recess comprising a recess bottom and a recess sidewall adjoining the recess bottom;
a mirror comprising a reflective layer on the recess bottom and the recess sidewall, wherein the mirror comprises a mirror sidewall portion on the recess sidewall facing away from the support structure;
a photodiode array mounted on the base opposite the support structure; and
a photodiode in the photodiode array configured to receive a reflected light beam from the mirror sidewall portion.

19. The fiber array unit of claim 18, wherein the photodiode array is attached to the base by a third optical glue layer.

20. The fiber array unit of claim 18, further comprising:
an anti-reflective trench located at a bottom surface of the inner base layer, wherein the reflected light beam is transmitted through the anti-reflective trench to the photodiode.
